(19) United States
(12) Patent Application Publication
(10) Pub. No.: US 2010/0325974 A1
(43) Pub. Date: Dec. 30, 2010

(54) ENVIRONMENTAL PROTECTION APPARATUS

(76) Inventor: Robin Shapero, Billericay Essex (GB)

Correspondence Address: JOEL D. SKINNER, JR.;SKINNER AND ASSOCIATES, 212 COMMERCIAL ST., HUDSON, WI, 54016, US

(21) Appl. No.: 12/692,669

(22) Filed: Jan. 25, 2010

(30) Foreign Application Priority Data
Jun. 25, 2009 (GB) 0910963.8

(51) Int. Cl. E06B 3/30; E06B 3/263

(52) U.S. Cl. 52/169.14; 52/202

(57) ABSTRACT

An environmental protection apparatus for protecting an opening such as windows, doors, airbricks, cat flaps, tumble dryer vents, meter cupboards, etc. against flood water. The apparatus includes a removable envelope arranged to surround the opening, a seal for sealing the envelope to the opening, and an attachment for releasably securing the envelope to the opening. The envelope is a box having a open side, positioned adjacent to the opening. The seal peripherally surrounds the open side of the box. The seal is a compressible material arranged to be compressed between the box and the opening. The attachment is an apertured plate securable to the opening. The releasable attachment is a hook arranged to be secured to the opening and an inter-engageable aperture in a portion of the box structure.

This application claims the benefit under 35 U.S.C. §119(e) of co-pending United Kingdom Patent Application No. 0910963.8, filed Jun. 25, 2009, which is hereby incorporated by reference.

This invention relates to environmental protection apparatus for protecting an opening against flood water.

Many homes are currently being built in flood plains and, together with homes that are near rivers which regularly flood, a need exists to protect windows, doors, airbricks, cat flaps, tumble dryer vents, meter cupboards, etc., with a form of protection to prevent ingress of water.

According to this invention there is provided environmental protection apparatus for protecting an opening located, in means defining said opening against flood water, said apparatus including removable enveloping means arranged to surround said opening, sealing means for sealing said enveloping means to said means defining said opening, and attachment means for releasably securing said enveloping means to said means defining said opening.

Preferably, said enveloping means comprises a box structure having an open side, said open side of said box structure, in use, being positioned adjacent said means defining said opening, and said sealing means peripherally surrounds said open side of said box structure.

Advantageously, said sealing means is a compressible material arranged to be compressed between said enveloping means and said means defining said opening.

Conveniently, said sealing means is a deformable elastomeric material attached to said enveloping means.

Advantageously, said attachment means comprises an apertured plate means securable to said means defining said opening, spigot means on said enveloping means arranged to engage in the apertures of said apertured plate means, and releasable securing means arranged in conjunction with said apertured plate means and said spigot means to compress said sealing means between said means defining said opening and said enveloping means.

Conveniently, said releasable securing means is hook means arranged to be secured to said means defining said opening and an inter-engageable aperture in a portion of said box structure.

Alternatively, said releasable securing means comprise an over-centre catch which is arranged to engage a hook whereby, in operation, said over-centre catch and hook are arranged to compress said sealing means.

Conveniently, said apertured plate means is arranged to be secured under a sill of a door or window.

The means defining an opening may be a door or window frame or airbrick or meter box or a structure within which the aforesaid are mounted.

Where said means defining an opening is a wall having an uneven surface, such as pebble dash, with which the sealing means is unable to make a water-tight seal, preferably a frame is sealed with a waterproof material around said opening and said enveloping means is arranged to be sealed by said sealing means to said frame.

In such an embodiment, said apertured plate means is fixedly secured to a lower, in use, portion of said frame.

The invention will now be described, by way of example, with reference to the accompanying drawings, in which:

FIG. 1 shows a front view of a first embodiment of a box structure in accordance with this invention,

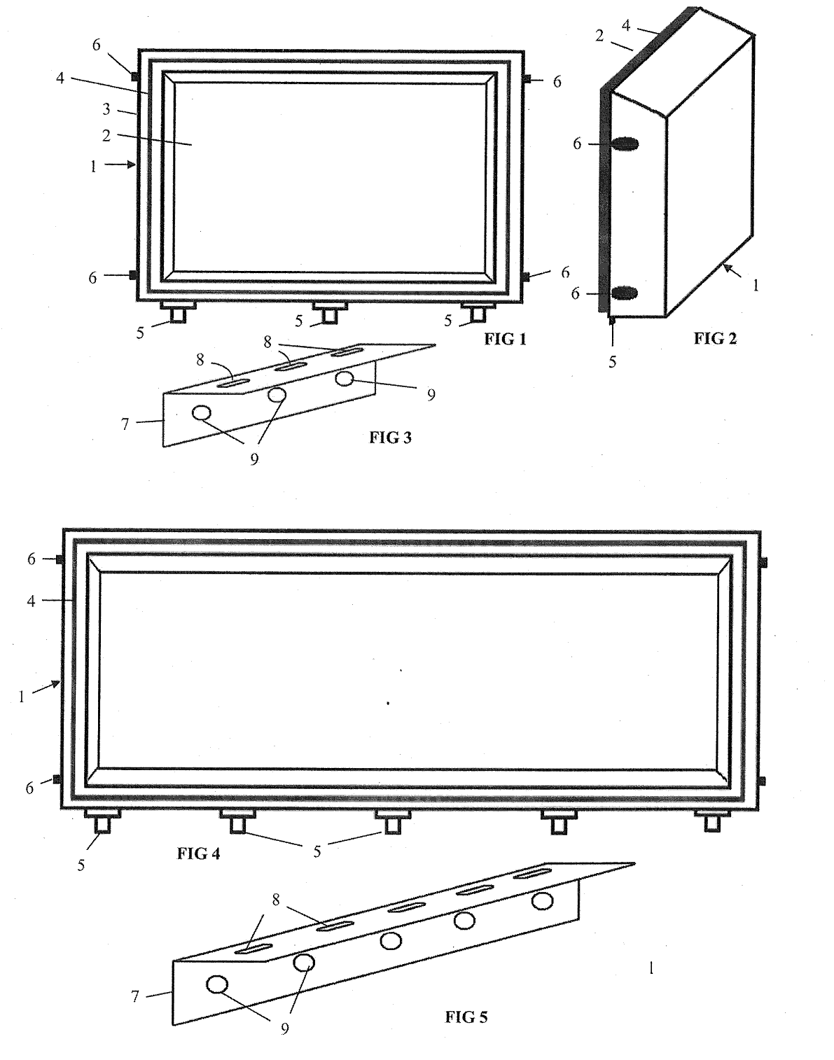

FIG. 2 shows a perspective view of the box structure of FIG. 1,

FIG. 3 shows an apertured plate for use with the box structure of FIGS. 1 and 2,

FIG. 4 shows a second embodiment of a box structure in accordance with this invention,

FIG. 5 shows a perspective view of an apertured plate for use in conjunction with the box structure of FIG. 4,

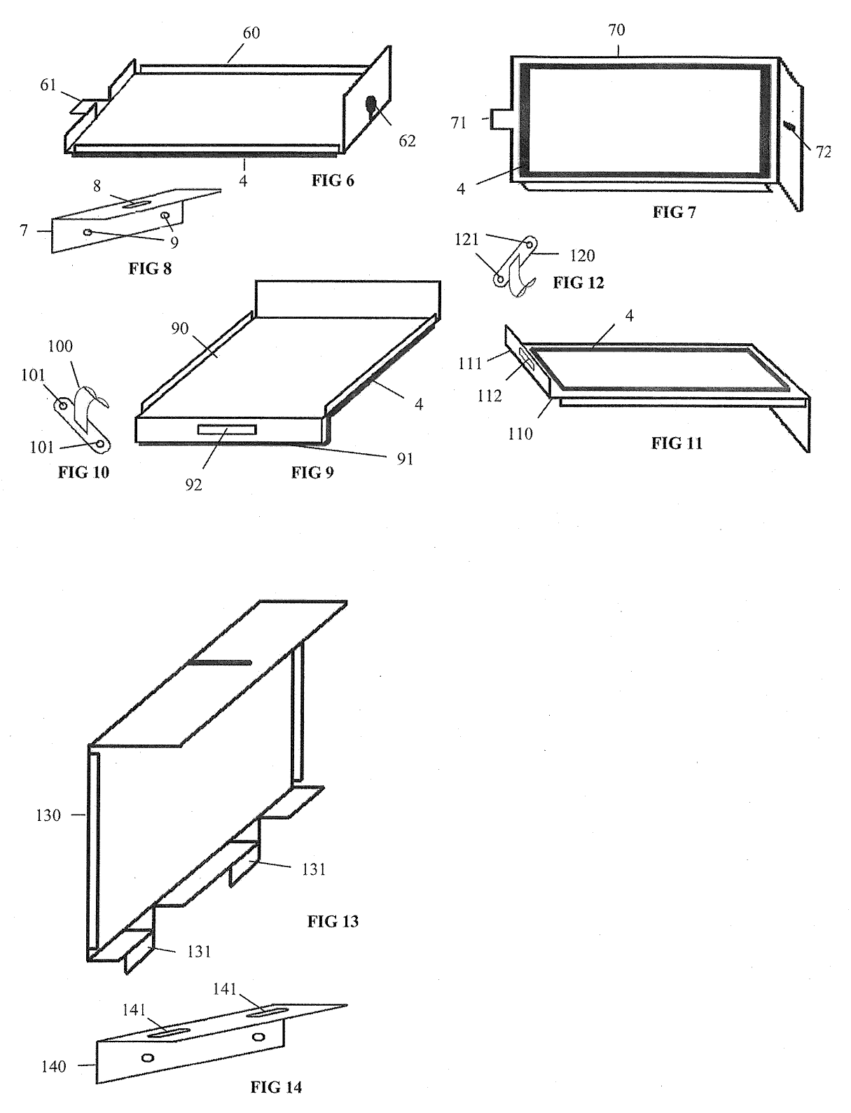

FIG. 6 shows a perspective view of a third box structure in accordance with this invention.

FIG. 7 shows a perspective view of a fourth box structure in accordance with this invention,

FIG. 8 shows a perspective view of an apertured plate for use with the box structure of FIG. 6 or 7,

FIG. 9 shows a perspective view of a fifth box structure in accordance with this invention,

FIG. 10 shows a perspective view of a hook for use with the box structure shown in FIG. 9,

FIG. 11 shows a perspective view of a sixth box structure in accordance with this invention,

FIG. 12 shows a perspective view of a hook for use in conjunction with the box structure of FIG. 11,

FIG. 13 shows a perspective view of a seventh box structure in accordance with this invention,

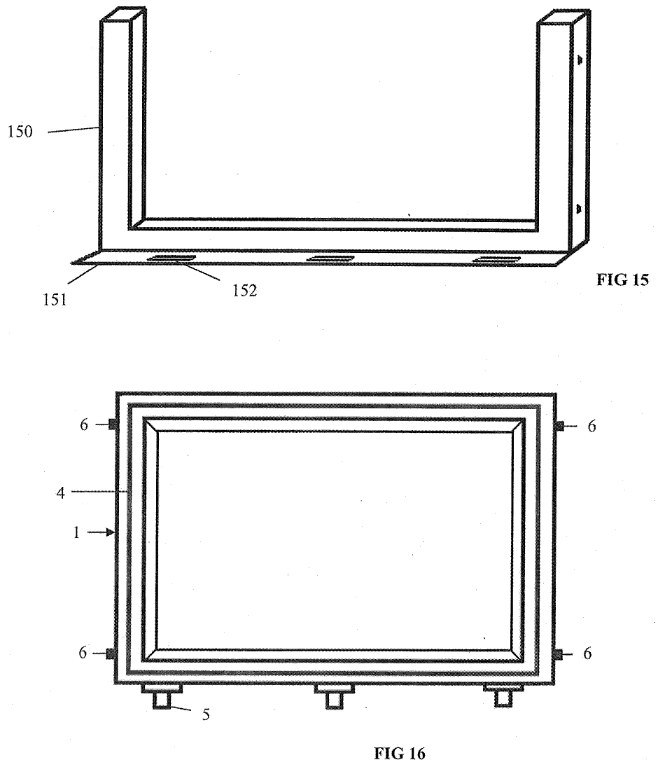

FIG. 14 shows an apertured plate for use with the box structure of FIG. 13,

FIG. 15 shows a partial perspective view of a frame for sealing to an uneven surface, and

FIG. 16 shows a front view of a box structure for sealing, to the frame of FIG. 15.

In the Figures like reference numerals denote like parts.

Referring to FIGS. 1 and 2, a box structure 1 is rectangularly shaped and has an open side 2 located in a wall 3 of the box. Surrounding the open side is a deformable elastomeric material 4 for forming a seal against a wall or frame defining an opening to be protected. The box structure is shaped and dimensioned to envelope a door, window, airbrick, cat flap, tumble dryer vent, or meter cupboard, etc., i.e. any opening where ingress of water is to be prevented.

Located equidistantly spaced along a lower edge of the box structure are three spigots 5 for location in apertures of a mounting plate, shown in FIG. 3. Located along vertical, in use, opposing sides of the box structure are two catches 6, each catch being arranged to releasably secure with a mating member (not shown) which is attached to a wall or frame of the opening to be protected. The catches may be, for example, over-centre catches having a loop which inter-engages with a hook that is attached to the wall or frame of the opening to be protected. The hook and the apertured plate are the only items of the apparatus which are permanently attached to the wall or frame of the opening to be protected.

Referring to FIG. 3, the apertured plate 7 is longitudinally L-shaped and has elongated slots 8 for receiving the spigots 5 and equi-spaced fixing holes 9 for securing the apertured plate to a wall or the underside of a door or windowsill. In use, the box structure is mounted so that the spigots 5 locate within the slots 8 with the top, end, of the box structure tilted away from the opening to be protected and then the top end is angularly moved so that the seal 4 is deformed to form a watertight seal around the opening to be protected and the catches 6 are used to secure the box structure to the wall or frame surrounding the door or window, or other opening to be protected. Closure of the catches applies equal pressure along the vertical axis of the box edges as well as around the horizontal edges so that the seal thereby forms a watertight seal between the box structure and buildings fabric.

In an alternative embodiment shown in FIGS. 4 and 5, the box structure has a width to fit over a patio door or French window. Because of its length, the box structure has five spigots and the apertured plate has five associated apertures 8 and, for convenience, five fixing holes 9.

Referring now to FIGS. 6, 7, 9 and 11, there are shown different shapes of box structure 60, 70, 90 and 110, respectively, for fitting over an airbrick, the shape being determined upon the shape and protrusion of the airbrick. In the embodiment shown in FIGS. 6 and 7, a detent 61, 71, respectively, is arranged to locate in an aperture 8 of an apertured plate 7 (shown in FIG. 8) and the box structure is held in position by a catch 62, 72, respectively. In the embodiments of FIGS. 9 and 11, the box structure has an end wall 91, 111, respectively, in which is located a rectangular aperture 92, 112, respectively, for inter-engagement with a hook 100, 120, respectively, that has fixing holes 101, 121, respectively, the hook 100, 120 being secured to the wall in which the airbrick is located.

A box structure 130 for a double-sided airbrick is shown in FIG. 13 and the box structure has a pair of detents 131 for locating in apertures 141 of an L-shaped plate 140 shown in FIG. 14.

If the surface against which the box structure is to be located is such that it is rough or uneven, such that the seal is unable to make a watertight seal, then it is necessary to provide a frame 150 (partially shown in FIG. 15) to be permanently located around the door or window opening, only the bottom portion of the frame being shown in FIG. 15. Fixedly located to a lower end of the frame 150 is an apertured plate 151 in which are situated elongated, rectangular, apertures 152 for receiving spigots 5 of a box structure 1, the seal 4 abutting the frame 150.

It will, therefore, be understood from the foregoing that the invention provides a rapidly fitted box structure which is removable for protecting an opening against Hood water.

1. An environmental protection apparatus for protecting an opening located in means defining said opening against flood water, said apparatus including removeable enveloping means arranged to surround said opening, sealing means for sealing said enveloping means to said means defining said opening, and attachment means for releasably securing said enveloping means to said means defining said opening.

2. An apparatus as claimed in claim 1, wherein said enveloping means comprises a box structure having an open side, said open side of said box structure, in use, being positioned adjacent said means defining said opening, and said sealing means peripherally surrounds said open side of said box structure.

3. An apparatus as claimed in claim 1, wherein said sealing means is a compressible material arranged to be compressed between said enveloping means and said means defining said opening.

4. An apparatus as claimed in claim 3, wherein said sealing means is a Deformable elastomeric material attached to said enveloping means.

5. An apparatus as claimed in claim 1, wherein said attachment means comprises an apertured plate means securable to said means defining said opening and further comprising, spigot means on said eveloping means arranged to engage in the apertures of said apertured plate means, and releasable securing means arranged in conjunction with said apertured plate means and said spigot means to compress said sealing means between said means defining said opening and said enveloping was means.

6. An apparatus as claimed in claim 5, wherein said releasable securing means is hook means arranged to be secured to said means defining said opening and an inter-engageable aperture in a portion of said box structure.

7. An apparatus as claimed in claim 5, wherein said releasable securing means comprise an over-centre catch which is arranged to engage a hook whereby, in operation, said over-centre catch and hook are arranged to compress said sealing means.

8. An apparatus as claimed in claim 5, wherein said apertured plate means is arranged to be secured under a sill of a door or window.

9. An apparatus as claimed in claim 1, wherein means defining an opening may be a door or window frame or airbrick or meter box or a structure within which the aforesaid are mounted.

10. An apparatus as claimed in claim 1, wherein a frame is sealed with a waterproof material around said opening and said enveloping means is arranged to be sealed by said sealing means to said frame.

11. An apparatus as claimed in claim 10, wherein said apertured plate means is fixedly secured to a lower, in use, portion of said frame.

12. (canceled)
